(19) United States
(12) Patent Application Publication
(10) Pub. No.: US 2023/0225304 A1
(43) Pub. Date: Jul. 20, 2023

(54) LIGHT UP LURE

(71) Applicant: IC Outdoors LLC, FARGO, ND (US)

(72) Inventor: Cody Shevich, Fargo, ND (US)

(21) Appl. No.: 18/156,232

(22) Filed: Jan. 18, 2023

Related U.S. Application Data
(60) Provisional application No. 63/301,109, filed on Jan. 20, 2022.

(51) Int. Cl. A01K 85/01

(52) U.S. Cl. CPC A01K 85/015

(57) ABSTRACT

A light up lure includes a switch in electrical communication with a light and a battery, the switch embedded in the body, the switch actuatable by a magnet external to the body to change a state of the light.

### BACKGROUND

The present disclosure claims priority to U.S. Provisional Patent Disclosure Ser. No. 63/301,109 filed Jan. 20, 2022.

The present disclosure relates to fishing lures, and more specifically, to fishing lures with a control system.

Lures have been used for fishing and spearing activities in many shapes and sizes. The purpose of a lure is generally to attract a desired prey to attack the bait or move to a certain location. Often, a bait is configured with hooks that may attach to the desired prey, in this case a fish, when the fish bites or attacks the bait. Alternatively, spearfishing lures may be configured without hooks and may be used to attract a fish to a particular location.

Spearfishing is an activity in which a person throws an object such as a spear, gig, or harpoon at a fish. The spear may strike the fish and the fisherman may retrieve the fish with the spear. Often, when spearfishing, it is preferred that the fish swims to a certain location before the spear is thrown. Spearfishing is a sport that is commonly performed on a frozen body of water. A frozen body of water may have a layer of ice on it such that a spearfishing house may be placed on the surface. A hole may be cut in the ice to allow for a person to throw the spear into the water below the ice. To strike the fish, the fish must be in a location that accommodates for the spear to move through the hole cut in the ice.

### SUMMARY

A light up lure according to one disclosed non-limiting embodiment of the present disclosure includes a body; a light embedded in the body; a battery in electrical communication with the light, the battery embedded in the body; and a switch in electrical communication with the light and the battery, the switch embedded in the body, the switch actuatable by a magnet external to the body to change a state of the light.

A further embodiment of any of the foregoing embodiments of the present disclosure includes wherein the switch comprises a latching reed switch.

A further embodiment of any of the foregoing embodiments of the present disclosure includes wherein the switch comprises a hall effect sensor.

A further embodiment of any of the foregoing embodiments of the present disclosure includes wherein the body is at least partially translucent.

A further embodiment of any of the foregoing embodiments of the present disclosure includes wherein the body is a single component.

A further embodiment of any of the foregoing embodiments of the present disclosure includes wherein the body is comprised of a multiple of pieces.

A further embodiment of any of the foregoing embodiments of the present disclosure includes wherein the body comprises at least a fin.

A further embodiment of any of the foregoing embodiments of the present disclosure includes wherein the body comprises at least a tail.

A further embodiment of any of the foregoing embodiments of the present disclosure includes wherein a hook is attached to the body.

A further embodiment of any of the foregoing embodiments of the present disclosure includes wherein a motive source powered by the battery, the motive source operated in response to the switch such that the motive source is powered when the light is illuminated.

A light up lure according to one disclosed non-limiting embodiment of the present disclosure includes a body; a light embedded in the body; a battery in electrical communication with the light, the battery embedded in the body; a switch in electrical communication with the light and the battery, the switch embedded in the body, the switch actuatable by a magnet external to the body to change a state of the light; and a near field communication (NFC) tag embedded in the body.

A further embodiment of any of the foregoing embodiments of the present disclosure includes wherein a motive source powered by the battery, the motive source operated in response to the switch such that the motive source is powered when the light is illuminated.

A further embodiment of any of the foregoing embodiments of the present disclosure includes wherein a controller in communication with the near field communication (NFC) tag, the controller operable to change an operational characteristic of the lure.

A light up lure according to one disclosed non-limiting embodiment of the present disclosure includes a body; a light embedded in the body; a battery in electrical communication with the light, the battery embedded in the body; a switch in electrical communication with the light and the battery, the switch embedded in the body, the switch actuatable by a magnet external to the body to change a state of the light; and a wireless charger in electrical communication with the battery, the wireless charger embedded in the body.

A further embodiment of any of the foregoing embodiments of the present disclosure includes wherein a motive source powered by the battery, the motive source operated in response to the switch such that the motive source is powered when the light is illuminated.

A further embodiment of any of the foregoing embodiments of the present disclosure includes wherein a near field communication (NFC) tag embedded in the body.

A further embodiment of any of the foregoing embodiments of the present disclosure includes wherein a controller in communication with the near field communication (NFC) tag, the controller operable to change an operational characteristic of the lure.

A light up lure according to one disclosed non-limiting embodiment of the present disclosure includes a body; a light embedded in the body; a battery in electrical communication with the light, the battery embedded in the body; and a switch in electrical communication with the light and the battery, the switch embedded in the body, the switch operable to change a state of the light via remote non-contact activation.

A further embodiment of any of the foregoing embodiments of the present disclosure includes wherein a controller in communication with the switch.

A further embodiment of any of the foregoing embodiments of the present disclosure includes wherein the controller is operable to receive control inputs to change a feature of the light up lure via a short-range communication protocol.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic view of a light up lure according to one disclosed non-limiting embodiment.

FIG. 2 is a schematic view of a light up lure showing how an external magnet may be used to control illumination thereof.

FIG. 3 is a schematic view of a light up lure according to another disclosed non-limiting embodiment.

FIG. 4 is a flowchart of a method for operating the light up lure.

### DETAILED DESCRIPTION

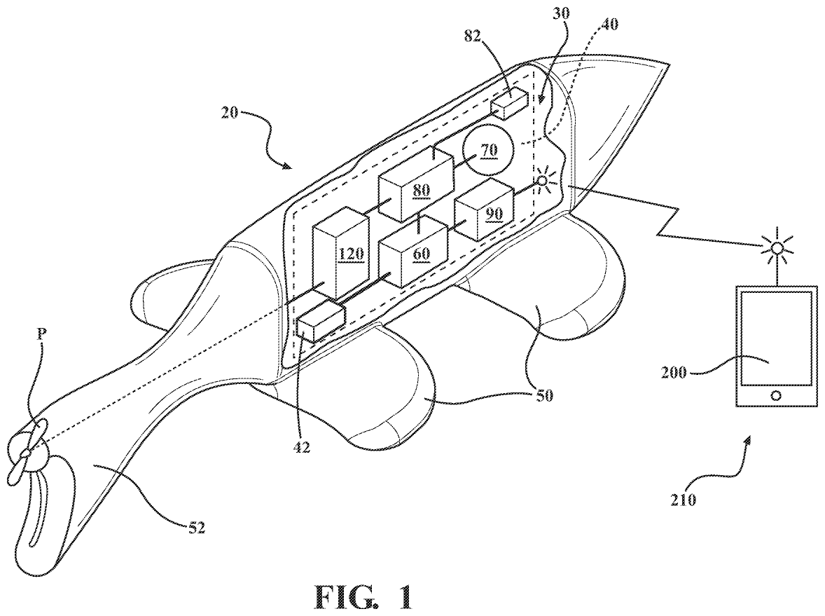

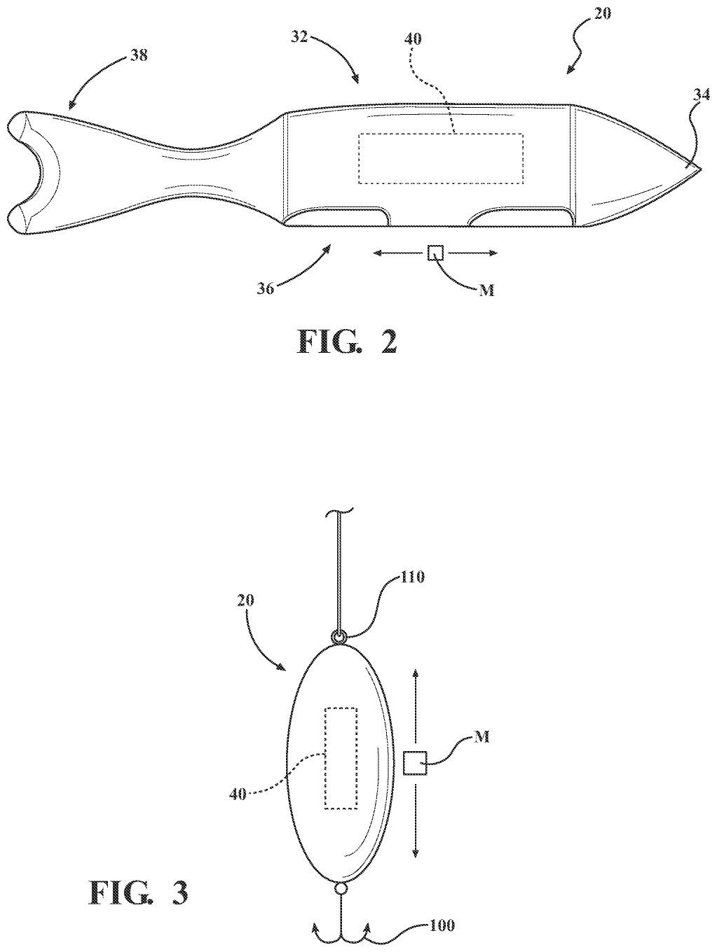

FIG. 1 schematically illustrates a light up lure 20 that includes a body 30 within which is embedded an electronic circuit 40. The circuit 40 may be operated, i.e., powered on and off by a remote magnet M (FIG. 2) as the circuit 40 is completely embedded in the body 30.

The body 30 may be shaped as a fish or other bait to attract prey. Alternatively, the body 30 may be formed in any shape. The size of the body 30 may vary in size depending on the specific desired prey. For example, a body 30 might be sized in a larger embodiment when attempting to attract a larger prey and smaller when attempting to attract a smaller prey.

The body 30 may include a top 32, a front 34, a bottom 36 and a rear 38 (FIG.

2). The body 30 may be manufactured with additional features or elements such as fins 50 and/or a tail 52. The fins 50 and/or tail 52 may be useful to simulate a particular prey, or the fins 50 and/or tail 52 may cause the body 30 to move in a certain fashion while in water. The fins 50 and/or tail 52 are examples of fixed features that may be manufactured as an element of the body 30. Alternatively, the fins 50 and/or tail 52 may be articulatable to move as the lure 20 moves though the water to provide a simulation of live movement.

The color of the body 30 may also vary depending on the desired prey, the environmental conditions, and the fisherman's particular fishing strategy. Fishermen have many different and widely varying fishing strategies. The body 30 may, for example, be manufactured in any color or color combination. Fishing lures are commonly manufactured in many different colors and color combinations.

The body 30 may be at least partially manufactured from plastic, rubber, metal, or other material. The body 30 may be at least partially translucent to permit illumination. The body 30 may be manufactured in one solid piece or may be comprised of multiple separately manufactured pieces. For example, the body 30 may be injection molded from one mold. Alternatively, the body 30 may be comprised of multiple separately molded pieces.

The circuit 40 may include a switch 60 in electrical communication with a light 70 and a battery 80 embedded within the body 30. The circuit 40 may also include a near field communication (NFC) tag 90 that permits communication with a remote NFC chip 200 such as that within a mobile device 210, laptop, etc. The NFC chip 200 is capable of transmitting and receiving data with the lure 20 via the NFC tag 90 as NFC offers a two-way communication channel. The NFC tag 90 operates through magnetic induction without power from the battery 80 and draws power from the mobile device 210. Although near field communication is disclosed in the illustrated embodiment, other short-range communication protocols such as Bluetooth, Wi-Fi, etc., may alternatively be utilized.

The switch 60, in one embodiment, may be a latching reed switch. The circuit 40 is thereby activated using the magnet M. Activating the latching reed switch operates to change the state of the switch 60 between on and off. The latching reed switch may be in the closed state or open state. The closed state is when electricity is allowed to travel from the battery 80 through the circuit to cause the light 70 to light. The open state is when the switch 60 does not complete the circuit and electricity is not allowed to travel from the battery 80 to the light 70. In one embodiment, the light 70 may be a light emitting diode of various colors and intensities.

In an embodiment, the battery 80 is a rechargeable battery that is charged through a wireless charger 82. The wireless charger 82 provides for remote inductive charging and permits the complete embedding of the circuit 40 within the body 30. That is, no ports are provided in the body 30 as the entire circuit 40 is embedded therein.

In another embodiment, the light-up lure 20 may include a motive source 120 such as an electric motor as a component of the circuit 40. In this embodiment, the motive source 120 powers a propuslor P to provide rotation of a propeller or flapping of the fins 50 and/or tail 52 to provide self-powered swimming movement to the lure 20. The movement may be part of a strategy to attract a desired prey.

To activate the latching reed switch that is embedded in the body 30, the magnet M is located adjacent to the body 30 (FIGS. 2 and 3). The magnet M is a separate component not attached to the body 30. The magnet M may be any type of magnet capable of exerting enough magnetic force upon the switch 60 such that the switch 60 is caused to activate. Movement of the magnet M with respect to the switch 60 permits remote non-contact operation. During passage of the magnet M by the body 30, the magnet M and the body 30 need not touch. During this activation process, there may be an air gap between the magnet M and the body 30. Once activated, the latching reed switch shall hold its state until the lure again passes the magnet.

In another embodiment, the switch 60 may be a hall effect sensor. A hall effect sensor may detect the presence and magnitude of a magnetic field. A hall effect sensor may be a solid-state switch that operates by using a combination of different types of semiconductors inside of an integrated circuit (IC) like package. A hall effect sensor may provide a similar function as described with the latching reed switch. The switch 60 may also be any other type of switching device that may be activated with a magnet M.

The body 30 may be manufactured with or without one or more hooks 100. When spearfishing, the body 30 generally may be manufactured without a hook. Spearfishing generally requires that the desired prey simply move to a certain location such that a fisherman may strike the desired prey with a spear. When used for spearfishing, the body 30 may be attached to a string, line, pole, or other object which holds the body 30 in a certain location. Alternatively, the lure 20 may be used for fishing using a rod. Typically rod fishing is such that a fisherman uses a rod to throw a lure with a hook into water after which the lure with a hook is retrieved using the rod. When the lure 20 is manufactured for rod fishing, the body 30 will typically be manufactured with one or more hooks 100. When the body 30 is manufactured with a hook, the hook or hooks may be configured in any manner. For example, hooks may be configured as a barbless hook or may have a barb at various positions on the body 30.

With reference to FIG. 3, the light-up lure 20 may also include an eyelet 110 to connect the body 30 to a string, line, pole, or other object for the purpose of holding the light-up lure 20. For example, the eyelet 100 may be attached to the top of the body 30 such that the light-up lure 20 may be hung at a particular depth in the water on a string. Alternatively, the eyelet 110 may be attached such that the light-up lure 20 may be pulled through the water.

In another embodiment, the NFC chip 200 transmits and receives data through communication with the NFC tag 90. The NFC chip 200 may be “swiped” or passed adjacent to the NFC tag 90, to receive and store data from the NFC tag 90, such as, for example, the type of lure, the fish caught, the fish spotted, the physical location, ambient conditions, e.g., temperature, pressure, light levels, speed, etc., and or other conditions and variables that may relate to catching fish. That is, the mobile device 210 may collect the information and associate that information with the particular lure 20 from the associated NFC tag 90.

The mobile device 210 may perform data processing based on the data obtained from the NFC tag 90. This data processing may provide for logging and charting to identify the conditions and locations when a fish was caught. That is, when a fish is caught, the mobile device 210 is used to swipe the near field communication (NFC) tag 90 and the information is recorded within a mobile application or other software package on the mobile device 210. The recorded information may include information obtained from the sensors of the mobile device, e.g., GPs data, temperature, time, etc. This permits a user to log information over a period of time, e.g., days, months, years, and develop a database of their personal experiences associated with catching fish.

The user may also use the logged information to change a feature of the light up lure 20, e.g., propulsion speed, light color, intensity, noise, etc. The feature of the light up lure 20 may be changed through the NFC tag 90 and/or though other short range communication protocols. For example, the desired feature may be selected in the mobile device 210 and the mobile device 210 communicates with the NFC tag 90 which, in turn may communicate with a control 42. The control 42 may include at least one processor, e.g., microprocessor, microcontroller, digital signal processor, etc., a memory, and an input/output (I/O) interface. The processor and the I/O interface are communicatively coupled to the memory. The memory may be embodied as various forms of ROM, RAM, which stores data and control algorithms such as the logic described herein to control, for example the light 70 and the motive source 120. The I/O interface is communicatively coupled to a number of hardware, firmware, and/or software components, including, for example, the NFC tag 90, the light, the motive source 120, etc. That is, the control 42 may provide programmable modifications to operational functions of the lure 20.

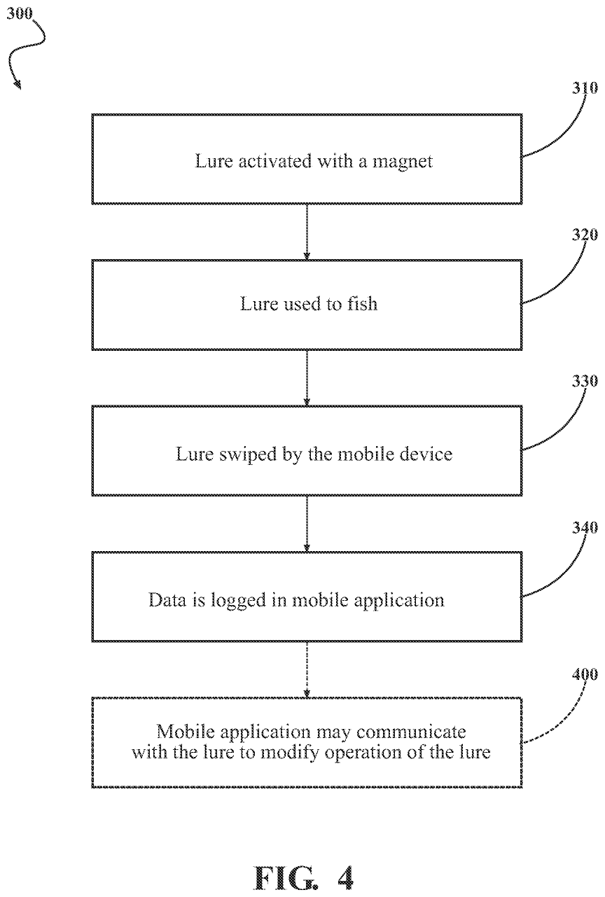

With reference to FIG. 4 a method 300 for operating the lure 20 is schematically illustrated. The functions may be programmed software routines capable of execution in various microprocessor-based electronics control embodiments and are represented herein as block diagrams.

Initially, the lure 20 may be activated with the magnet (310). The lure 20 is then used to fish (320). Once a fish is caught, the lure 20 may be swiped by the mobile device 210 (330) to receive data from the NFC tag 90 which is recorded within a mobile application or other software package on the mobile device 210. The data is then logged (340) in the mobile application to develop a database of the user's personal experiences.

In some instances, the mobile application may be used to communicate with the NFC tag 90 which, in turn communicate with the control 42 to modify operation of the lure 20 (400). Alternatively, the mobile application may communicate via other short range communication protocols to change a feature of the lure 20.

NFC communication is a relatively straightforward procedure compared to making changes or pushing buttons on the lure. By permitting remote non-contact activation, the NFC communication provides a configuration that reduces potential failure points. In addition, embedding within the body 30 ensures that water may not contact the elements embedded therein.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A light up lure, comprising:
a body;
a light embedded in the body;
a battery in electrical communication with the light, the battery embedded in the body; and
a switch in electrical communication with the light and the battery, the switch embedded in the body, the switch actuatable by a magnet external to the body to change a state of the light.

2. The light up lure as recited in claim 1, wherein the switch comprises a latching reed switch.

3. The light up lure as recited in claim 1, wherein the switch comprises a hall effect sensor.

4. The light up lure as recited in claim 1, wherein the body is at least partially translucent.

5. The light up lure as recited in claim 4, wherein the body is a single component.

6. The light up lure as recited in claim 4, wherein the body is comprised of a multiple of pieces.

7. The light up lure as recited in claim 4, wherein the body comprises at least a fin.

8. The light up lure as recited in claim 4, wherein the body comprises at least a tail.

9. The light up lure as recited in claim 4, further comprising a hook attached to the body.

10. The light up lure as recited in claim 1, further comprising a motive source powered by the battery, the motive source operated in response to the switch such that the motive source is powered when the light is illuminated.

11. A light up lure, comprising:
a body;
a light embedded in the body;
a battery in electrical communication with the light, the battery embedded in the body;
a switch in electrical communication with the light and the battery, the switch embedded in the body, the switch actuatable by a magnet external to the body to change a state of the light; and
a near field communication (NFC) tag embedded in the body.

12. The light up lure as recited in claim 11, further comprising a motive source powered by the battery, the motive source operated in response to the switch such that the motive source is powered when the light is illuminated.

13. The light up lure as recited in claim 12, further comprising a controller in communication with the near field communication (NFC) tag, the controller operable to change an operational characteristic of the lure.

14. A light up lure, comprising:
a body;
a light embedded in the body;
a battery in electrical communication with the light, the battery embedded in the body;
a switch in electrical communication with the light and the battery, the switch embedded in the body, the switch actuatable by a magnet external to the body to change a state of the light; and
a wireless charger in electrical communication with the battery, the wireless charger embedded in the body.

15. The light up lure as recited in claim 14, further comprising a motive source powered by the battery, the motive source operated in response to the switch such that the motive source is powered when the light is illuminated.

16. The light up lure as recited in claim 14, further comprising a near field communication (NFC) tag embedded in the body.

17. The light up lure as recited in claim 16, further comprising a controller in communication with the near field communication (NFC) tag, the controller operable to change an operational characteristic of the lure.

18. A light up lure, comprising:
a body;
a light embedded in the body;
a battery in electrical communication with the light, the battery embedded in the body; and
a switch in electrical communication with the light and the battery, the switch embedded in the body, the switch operable to change a state of the light via remote non-contact activation.

19. The light up lure as recited in claim 18, further comprising a controller in communication with the switch.

20. The light up lure as recited in claim 19, wherein the controller is operable to receive control inputs to change a feature of the light up lure via a short-range communication protocol.
